(19) United States
(12) Patent Application Publication
(10) Pub. No.: US 2007/0026113 A1
(43) Pub. Date: Feb. 1, 2007

(54) Vacuum skin package for cheese

(76) Inventors: Andrea Fanfani, Milan (IT); Laura Bellini, Milan (IT)

Correspondence Address: Sealed Air Corporation, P.O. Box 464, Duncan, SC, 29334, US

(21) Appl. No.: 11/489,202

(22) Filed: Jul. 19, 2006

(30) Foreign Application Priority Data
Jul. 19, 2005 (EP) 05106604.1
Jun. 27, 2006 (EP) 06116120.4

(51) Int. Cl. B32B 27/08

(52) U.S. Cl. 426/127

(57) ABSTRACT

The invention relates to a vacuum skin package suitable for the packaging of respiring cheeses, such as gassing cheeses and moulded cheeses. The package comprises a support member and a flexible skin-forming film draped over the cheese product wherein the support member has an oxygen transmission rate in the range of from 80 to 500 cm³/m²-day-bar at 23° C. and 0% RH and the flexible film has an oxygen transmission rate greater than 60 cm³/m²-day-bar at 23° C. and 0% RH.

The present invention relates to a vacuum skin package for the packaging of cheese. In particular the present invention relates to a vacuum skin package for the packaging of respiring cheeses and to a method for vacuum skin packaging a cheese product.</technical-field>

Vacuum skin packaging is a process well known in the art for using a thermoplastic packaging material to enclose a food product. The vacuum skin packaging process is in one sense a type of thermoforming process in which an article to be packaged serves as the mold for a forming web. An article may be placed on a support member, which may be flat or shaped (e.g. tray-shaped, bowl-shaped or cup-shaped). The supported article is then passed to a chamber where a top flexible film is drawn upward against a heated dome. The softened top flexible film is then draped over the article. The movement of the film is controlled by vacuum and/or air pressure. In a vacuum skin packaging arrangement, the interior of the container is vacuumized before final welding of the top flexible film to the support member. In a vacuum skin package the upper heated film thus forms a tight skin around the product and is sealed to the support. Vacuum skin packaging is described in many references, including French Patent Publication 1,258,357; French Patent Publication 1,286,018; Australian Patent Publication 3,491,504; U.S. RE Pat. No. 30,009; U.S. Pat. No. 3,574,642; U.S. Pat. No. 3,681,092; U.S. Pat. No. 3,713,849; U.S. Pat. No. 4,055,672; and U.S. Pat. No. 5,346,735.

The term “vacuum skin packaging” (hereinafter “VSP”) as used herein indicates that the product is packaged under vacuum and the space containing the product is substantially evacuated from gases at the moment of packaging. The top flexible film is sometimes referred to as “skin-forming” film.

Several hundreds of different kinds of cheese are produced today with different packaging requirements. Some cheese products, particularly semi-hard cheeses, like Swiss cheese, emit a significant amount of carbon dioxide over time as a consequence of their curing process. The evolved carbon dioxide must be allowed to escape the package in order to maintain the properties of the cheese and the integrity of the package. If not allowed to escape the evolved carbon dioxide collects inside the package creating a so-called “ballooning effect,” which the average consumer may perceive as a defect in the packaging and an indication of possible spoilage. These cheese types are often referred to as “gassing” cheeses.

On the other hand, moulded cheeses, such as blue cheese, require a type of packaging that allows them to “breathe,” that is to exchange oxygen with the outer atmosphere, in order to keep the moulds alive and therefore the flavor of the product unchanged.

The gassing cheeses and the moulded ones are herein referred to as “respiring” cheeses due to their gas exchange requirements.

Due to their different breathing requirements gassing cheeses and moulded cheeses are typically stored and sold in different types of packaging. Gassing cheeses are generally available to the consumer in hermetic packages, often under vacuum or under a modified atmosphere. On the other hand moulded cheeses are mostly sold in non-hermetic packages, such as waxed paper wrappings.

It would be desirable to provide a common packaging system for both gassing and moulded cheeses that may be useful in adapting to the different respiration requirements of these cheese products and that may also help reduce packaging inventory requirements by the cheese producer.

By selecting the oxygen barrier properties of the skin-forming film and of the support member, it is possible to obtain a vacuum skin package for respiring cheese (both gassing and moulded) which may satisfy the desired shelf-life requirements and the optimal preservation of the organoleptic properties of the cheese product. Advantageously, by appropriate selection of the oxygen barrier properties of the support member of the package, it possible to meet the different respiration requirements of gassing and moulded cheeses by changing the skin-forming film. Thus, only a limited number of inventoried packaging materials is required to meet most respiring cheese requirements.

In a first aspect of the present invention, a vacuum skin package may comprise a support member, a cheese product, and a flexible film. The support member may have an oxygen transmission rate of 80 to 500 cm³/m²-day-bar at 23° C. and 0% relative humidity. The flexible film draped over the cheese product may have an oxygen transmission rate greater than 60 cm³/m²-day-bar at 23° C. and 0% relative humidity.

A second aspect of the invention is a method of making a vacuum skin package. A support member is provided. A cheese product is loaded onto the support member. A flexible film is draped over the cheese product and over the support member. The support member has an oxygen transmission rate of 80 to 500 cm³/m²-day-bar at 23° C. and 0% relative humidity. The flexible film draped over the cheese product has an oxygen transmission rate greater than 60 cm³/m²-day-bar at 23° C. and 0% relative humidity.

The oxygen transmission rate (“OTR”) is measured according to ASTM D-3985 and may be made by using an OX-TRAN instrument by Mocon. Unless otherwise stated, the OTR values throughout the text refer to measures made at 23° C. and 0% relative humidity (hereinafter “RH”).

The OTR value of the support member is independent of the OTR value of the flexible skin-forming film, that is, the two OTR values do not have to be the same.

It is known that the oxygen barrier properties of certain materials, such as (ethylene-co-vinyl alcohol) copolymers (EVOH) and polyamides, vary greatly with humidity, their OTR values generally increasing with increasing humidity. The OTR values of the support member and of the flexible skin-forming film may also have a different dependence from humidity the one with respect to the other.

The combination of a support member and a skin-forming film having different oxygen transmission properties represents a potential advantage of the package of the present invention with respect to other cheese packages, such as shrink bags or pouches. Such combination allows flexibility in modulating the gas permeation properties of the overall package. For instance, gassing cheeses, like Swiss cheese, are better preserved in an environment that allows a moderate passage of oxygen; whereas, moulded cheeses, like blue cheese, are better preserved in an environment with significant oxygen transmission properties. With the various aspects of the packages of the present invention, these different requirements may be met by changing, for instance, only the flexible skin-forming film.

Some examples of suitable combinations of oxygen transmission properties for the support member and the flexible skin-forming film are reported below, the numbers being OTR values at 23° C. and 0% RH expressed in cm³/m²-day-bar.

Support 80 to 250/Skin-forming film 60 to 300;

Support 80 to 250/Skin-forming film 100 to 200;

Support 80 to 250/Skin-forming film 150 to 500;

Support 80 to 250/Skin-forming film 500 to 1000;

Support 250 to 350/Skin-forming film 60 to 300;

Support 250 to 350/Skin-forming film 100 to 200;

Support 250 to 350/Skin-forming film 150 to 500;

Support 250 to 350/Skin-forming film 500 to 1000.

OTR of the skin-forming film may be at most 10,000 cm³/m²-day-bar. OTR of the skin-forming film may be higher than 10,000 cm³/m²-day-bar.

For example, a shelf-live in the order of 9 weeks may be obtained for a moulded type cheese like Roquefort by combining a support member with an OTR in the range of 80 to 500 cm³/m²-day-bar, preferably in the range of 80 to 250 cm³/m²-day-bar, with a skin-forming flexible film with an OTR in the range of 500 to 1,000 cm³/m²-day-bar, preferably in the range of 600 to 1,000 cm³/m²-day-bar.

Gassing cheeses, like Asiago, Leerdammer, and Emmentaler, may be preserved in a package comprising a support member with an OTR in the range of 80 to 250 cm³/m²-day-bar and a skin-forming flexible film with an OTR in the range of 60 to 300 cm ³/m²-day-bar, preferably 100 to 200 cm³/m²-day-bar.

Materials suitable for both the support member and the flexible skin-forming film include those having carbon dioxide transmission rates (measured using an analytical technique analogous to ASTM D-3985 at 23° C. and 0% RH) greater than 250 cm ³/m²-day-bar, preferably greater than 300 cm³/m²-day-bar.

The materials suitable for the support member include those having OTR values at 23° C. and 100% RH (measured using an analytical technique analogous to ASTM D-3985 at 23° C. and 0% RH, wherein both sides of the specimens to be tested are kept in contact with water for four days before being tested) greater than 100 cm³/m²-day-bar, typically greater than 140 cm³/m²-day-bar.

The OTR values at 23° C. and 100% RH of materials suitable for the flexible skin-forming film may be greater than 300 cm³/m²-day-bar, for example, greater than 450 cm³/m²-day-bar.

The support member and the flexible skin-forming film may be obtained from multi-layer plastic materials. They may include any number of layers from 2 to as many as 20. Preferably they will include from 4 to 15 and more preferably 5 to 10 layers. The materials to be used for the support member may typically require some rigidity and good thermoforming properties; whereas, the materials to be used for the skin-forming film may generally require stretchability and flexibility.

The skin forming film in the VSP process may possess a high degree of formability/stretchability to help avoid wrinkles and other irregularities in the final packaged product.

The support member may comprise plastic materials, and may have a thickness greater than any of the following: 100, 120, 150, 170, and 200 μm. The support member may have a thickness of less than any of the following: 1200, 1000, 850, and 700 μm.

The skin-forming film may comprise plastic material, and may have a thickness greater than any of the following: 35, 50, 60, and 70 μm. The skin-forming film may have a thickness of less than any of the following: 200, 180, 150, and 120 μm.

The support member and/or the skin-forming film may each independently comprise multi-layer thermoplastic material. For example, the support member and the skin-forming film may each independently comprise any of the following: at least one outer layer, an oxygen barrier layer, and at least one heat-sealable surface layer.

The oxygen barrier layer, if present, may comprise any of the polymers known in the art for their oxygen barrier properties, such as EVOH, PVDC, polyesters, polyamides, and blends thereof. Exemplary blends include blends of polyamides and EVOH in weight ratios from 10:90 to 90:10.

PVDC is any vinylidene chloride copolymer wherein a major amount of the copolymer comprises vinylidene chloride and a minor amount of the copolymer comprises one or more unsaturated monomers copolymerisable therewith, typically vinyl chloride, and alkyl acrylates or methacrylates (e.g. methyl acrylate or methacrylate) and the blends thereof in different proportions. A PVDC barrier layer may contain plasticizers and/or stabilizers as known in the art.

EVOH is the saponified product of ethylene-vinyl ester copolymers, generally of ethylene-vinyl acetate copolymers, wherein the ethylene content is typically comprised between 20 and 60% by mole and the degree of saponification is generally higher than 85% preferably higher than 95%.

Polyamides used in oxygen barrier layers may be homo- or co-polyamides. This term specifically includes those aliphatic polyamides or copolyamides commonly referred to as e.g. polyamide 6 (homopolymer based on ε-caprolactam), polyamide 6,9 (homopolycondensate based on hexamethylene diamine and azelaic acid), polyamide 6,10 (homopolycondensate based on hexamethylene diamine and sebacic acid), polyamide 6,12 (homopolycondensate based on hexamethylene diamine and dodecandioic acid), polyamide 11 (homopolymer based on 11-aminoundecanoic acid), polyamide 12 (homopolymer based on co-aminododecanoic acid or on laurolactam), polyamide 6/12 (polyamide copolymer based on ε-caprolactam and laurolactam), polyamide 6/6,6 (polyamide copolymer based on ε-caprolactam and hexamethylenediamine and adipic acid), polyamide 6,6/6,10 (polyamide copolymers based on hexamethylenediamine, adipic acid and sebacic acid), modifications thereof and blends thereof. The term also includes crystalline or partially crystalline, aromatic or partially aromatic, polyamides, like MXD,6/MXD,I that is an aromatic copolyamide formed in the reaction between metaxylylenediamine, adipic acid and isophtalic acid.

The term “polyesters” refers to polymers obtained by the polycondensation reaction of dicarboxylic acids with dihydroxy alcohols. Suitable dicarboxylic acids are, for instance, terephthalic acid, isophthalic acid, 2,6-naphthalene dicarboxylic acid and the like. Suitable dihydroxy alcohols are for instance ethylene glycol, diethylene glycol, 1,4-butanediol, 1,4-cyclohexanedimethanol and the like. Examples of useful polyesters include poly(ethylene 2,6-naphtalate), poly(ethylene terephthalate), and copolyesters obtained by reacting one or more dicarboxylic acids with one or more dihydroxy alcohols.

The thickness of the oxygen barrier layer, if present, may be determined to provide the overall laminate with an OTR at 23° C. and 0% RH that is desirable for the specific requirements of the type of cheese being packed.

The heat-sealable surface layer may comprise materials chosen from the group of ethylene homo-and co-polymers, propylene homo- and co-polymers, ionomers and the like as well as blends of these polymers in any proportions. Suitable blends for the heat-sealable layer also include peelable blends. As used herein, the term “copolymer” refers to a polymer derived from two or more types of monomers, and includes terpolymers. Ethylene homopolymers include high density polyethylene (HDPE) and low density polyethylene (LDPE). Ethylene copolymers include ethylene/alpha-olefin copolymers and ethylene/unsaturated ester copolymers. Ethylene/alpha-olefin copolymers generally include copolymers of ethylene and one or more comonomers selected from C₃ to C₂₀ alpha-olefins, such as 1-butene, 1-pentene, 1-hexene, 1-octene, 4-methyl-1-pentene and the like.

Ethylene/alpha-olefin copolymers generally have a density in the range of from about 0.86 to about 0.94 g/cm³. The term linear low density polyethylene (LLDPE) is generally understood to include that group of ethylene/alpha-olefin copolymers which fall into the density range of about 0.915 to about 0.94 g/cm³ and particularly about 0.915 to about 0.925 g/cm³. Sometimes linear polyethylene in the density range from about 0.926 to about 0.94 g/cm³ is referred to as linear medium density polyethylene (LMDPE). Lower density ethylene/alpha-olefin copolymers may be referred to as very low density polyethylene (VLDPE) and ultra-low density polyethylene (ULDPE).

Ethylene/alpha-olefin copolymers may be obtained by either heterogeneous or homogeneous polymerization processes.

Another useful ethylene copolymer is ethylene/unsaturated ester copolymer, which is the copolymer of ethylene and one or more unsaturated ester monomers.

Useful unsaturated esters include vinyl esters of aliphatic carboxylic acids, where the esters have from 4 to 12 carbon atoms, such as vinyl acetate, and alkyl esters of acrylic or methacrylic acid, where the esters have from 4 to 12 carbon atoms.

Useful propylene copolymers include propylene/ethylene copolymers (EPC), which are copolymers of propylene and ethylene having a majority weight percent content of propylene, and propylene/ethylene/butene terpolymers (EPB), which are copolymers of propylene, ethylene, and 1-butene.

The heat-sealable layer may comprise any of LDPE, ethylene/alpha-olefin copolymers, ionomers, ethylene-vinyl acetate copolymers, and blends thereof. The thickness of the heat-sealable surface layer may be between 2 and 80 μm, more preferably from about 2 to about 50 μm.

The outer layer may comprise materials chosen from the group of ethylene homo- and co-polymers, propylene homo- and co-polymers, ionomers, and polyesters. The thickness of the outer layer may be between 2 and 400 μm, more preferably from about 2 to about 50 μm.

The support member and/or the skin-forming film may comprise additional layers, such as any of the following: tie or adhesive layers, abuse layers, and the like. The additional layers may serve the purpose of providing the necessary mechanical properties, such as modulus, puncture resistance, abuse resistance, etc. or improving the bond between the various layers.

A non-limiting example of a suitable multi-layer film for the support member of the package of the present invention is, for instance, an eight-layer material with an ionomer heat-sealable layer having the following layer composition:

Support# 1:
Io (2 μm)/EVA (9 μm)/Adh (28 μm)/LDPE (144 μm)/Adh (7 μm)/LDPE (11 μm)/Adh (10 μm)/PP (370 μm).

An alternative example of a support member multi-layer film is a ten-layer material with an EVA heat-sealable layer having the following layer composition:

Support # 2:
EVA (2 μm)/EVA (8 μm)/Adh (7 μm)/PS (95 μm)/Adh (8 μm)/50 wt. % PA6/12+50 wt. % EVOH (3 μm)/Adh (8 μm)/PS (98 μm)/Adh (12 μm)/PETG (12 μm).

Another example of a multi-layer film support member is Support # 3, which has the same layer sequence as Support # 2 but with the following barrier layer composition: 70 wt. % PA6/12+30 wt. % EVOH.

Still another example of a multi-layer film support member is Support # 4, which is a ten-layer film with an EVA heat-sealable layer having the following layer composition:
EVA (3 μm)/EVA (13 μm)/Adh (11 μm)/PS (140 μm)/Adh (12 μm)/LDPE (12 μm)/Adh (14 μm)/PS (140 μm)/Adh (17 μm)/PETG (18 μm).

In the above descriptions: Io is an ionomer; EVA is an ethylene-vinyl acetate copolymer; Adh is a tie resin, such as a maleic anhydride-grafted ethylene copolymer; PS is a blend of polystyrene and styrene-butadiene-styrene block copolymer; PP is a propylene homopolymer; PA 6/12 is a polyamide 6/12, and PETG is a copolyester formed in the reaction between terephthalic acid, ethylene glycol, and 1,4-cyclohexanedimethanol.

In order to provide the package of the invention with an easy-to-open feature the EVA layer adjacent to the heat-sealable food-contact layer in the materials described above may be replaced with a layer comprising, or consisting of, a blend of resins having a low cohesive strength. Blends with low cohesive strength that may be used include those described, for example, in WO 99/54398.

The multi-layer materials suitable for both the support member and the skin-forming film may be produced using common techniques known in the art such as extrusion, co-extrusion or by heat- or glue-lamination, extrusion coating and the like.

The materials, in particular the materials suitable for the skin-forming film, may be cross-linked. The preferred method of cross-linking is by electron-beam irradiation and is well known in the art. One skilled in the art can readiliy determine the radiation exposure level suitable for a particular application. Generally, however, radiation dosages of up to about 250 kGy, typically between 90 and 220 kGy, with a preferred dosage of between 110 and 200 kGy.

A non-limiting example of a suitable multi-layer film for the skin-forming film of the package of the present invention is for instance a nine-layer material with a LDPE heat-sealable layer having the following layer composition:

Skin-Forming Film # 1:
LDPE (5 μm)/LDPE (12 μm)/EVA (18 μm)/Adh (3 μm)/PA 6/66 (6 μm)/Adh (4 μm)/EVA (12 μm)/LDPE (28 μm)/HDPE (10 μm).

Another example of a skin-forming film is the following Skin-forming film # 2:
LDPE (6 μm)/LDPE (14 μm)/EVA (19 μm)/Adh (3 μm)/PA 6/66 (10 μm)/Adh (4 μm)/EVA (11 μm)/LDPE (26 μm)/HDPE (10 μm).

Another skin-forming film example is an eight-layer material with a LLDPE heat-sealable layer having the following layer composition:

Skin-Forming Film # 3:

LLDPE (13 μm)/EVA (28 μm)/Adh (5 μm)/PA 6/66 (10 μm)/Adh (5 μm)/EVA (28 μm)/Adh (6 μm)/PETG (5 μm).

In the examples, PA6/6,6 is a polyamide 6/6,6.

Still another skin-forming film example is an eight-layer material with an LDPE heat-sealable layer having the following layer composition:

Skin-Forming Film # 4:

LDPE (9 μm)/EVA (5 μm)/EVA (25 μm)/Adh (3 μm)/LDPE (7 μm)/Adh (3 μm)/EVA (36 μm)/HDPE (12 μm).

The oxygen transmission properties of the materials described above are reported in Table 1.

TABLE 1

| | OTR 23° C. | |
|---|---|---|
| | and 0% RH | OTR 23° C. and 100% RH |
| Material | (cm³/m²-day-bar) | (cm³/m²-day-bar) |
| Support # 1 | 135 | 140 |
| Support # 2 | 83 | 200 |
| Support # 3 | 200 | 170 |
| Support # 4 | 220 | 220 |
| Skin-forming film # 1 | 182 | 650 |
| Skin-forming film # 2 | 106 | 456 |
| Skin-forming film # 3 | 97 | 303 |
| Skin-forming film # 4 | 970 | — |

Non-limiting examples of packages according to the present invention are for instance:
Support # 1/Emmentaler cheese/Skin-forming film # 3;
Support # 1/Asiago cheese/Skin-forming film # 3;
Support # 1/Roquefort cheese/Skin-forming film # 4; and
Support # 2/Leerdammer cheese/Skin-forming film # 1.

Packaging tests were performed to evaluate the shelf-life of different gassing cheeses with different support/skin-forming film combinations. Chunks of approximately 200 g of the different cheeses were vacuum skin packaged using different support/skin-forming film combinations and stored at 6-7° C. in daylight. Checks were performed 7 or 9 weeks after packaging for gas formation (“ballooning”), visible mould presence inside the packs and odor and taste after unpacking. The results are reported in Table 2.

TABLE 2

| | | Skin- | | | | Odor/ |
|---|---|---|---|---|---|---|
| | Support | forming | | | | Taste |
| Cheese | # | film # | Weeks | Moulds | Balloning | change |
| Asiago | 1 | 3 | 7 | No | No | Slight |
| Asiago | 3 | 1 | 9 | No | No | Slight |
| Asiago | 1 | Comp.* | 7 | No | Yes | Severe |
| Leerdammer | 2 | 1 | 9 | No | No | None |
| Leerdammer | 3 | 1 | 9 | No | No | None |

*Comparative skin-forming film having an OTR value at 23° C. and 0% RH and 100% RH of 44 cm³/m²-day-bar and 90 cm³/m²-day-bar, respectively.

Another aspect of the present invention relates to a method of making a vacuum skin package for cheese, the method comprising the steps of:
providing a support member;
loading a cheese product on the support member; and
draping a flexible film over the cheese product to enclose the cheese product on the support member. The support member may have an oxygen transmission rate (measured according to ASTM D-3985) in the range of from 80 to 500 cm³/m²-day-bar at 23° C. and 0% RH. The flexible film may have an oxygen transmission rate (measured according to ASTM D-3985) greater than 60 cm³/m²-day-bar at 23° C. and 0% RH.

The skin-forming film may be fed to the upper section of a heated vacuum chamber comprising an upper and a lower section. A vacuum may be applied from the outside to draw the skin-forming film into a concave form against the inwardly sloping walls of the upper section of the chamber and against the ports contained in the horizontal wall portion thereof (the top of the dome). Any conventional vacuum pump can be used to apply the vacuum. The skin-forming film may be pre-heated before the foregoing operation to render it more formable and thus better able to assume a concave shape in the upper section of the vacuum chamber.

The product to be packaged is positioned on the support member, which may be flat or shaped, typically tray-shaped. The product/support member may then be placed on a platform that is carried into the vacuum chamber, in the lower section thereof, just below the dome. The support member may be shaped off-line or, alternatively, in-line at an initial station on the vacuum packaging machine. Then the vacuum chamber is closed by moving the upper section down onto the lower one. During this sequence of operations vacuum is may be constantly applied to retain the concave shape of the laminate. Once the vacuum chamber is closed, vacuum is applied also in the lower section of the vacuum chamber in order to evacuate the space between the support member and the top skin-forming film. Vacuum in the upper section of the vacuum chamber may continue to be applied to retain the concave shape of the skin-forming film until the area between the support and the skin-forming film is evacuated, then it may be released so that atmospheric pressure is admitted. This will collapse the softened top skin-forming film over the product and the support, as the atmosphere pushing the skin-forming film from the top and the vacuum pulling it from the bottom will cooperatively work to have the skin-forming film substantially conform to the shape of the product to be packaged on the support member.

For some types of cheeses, for instance the ones having a sponge-like structure like Asiago, it might be necessary to control the speed of evacuation of the chamber to prevent the collapse of the cheese structure. Optionally, after the evacuation step has been completed, a suitably selected purging gas or gas mixture could be flushed over the product to generate a very low residual gas pressure into the package.

Heat-sealing bars or other sealing means may be present in the vacuum chamber to carry out a perimeter heat-seal of the skin-forming film to the support member.

The packaging method of the invention may be performed on currently available VSP machines, like the Multivac® CD6000 or the Multivac® R270.

What is claimed is:

1. A vacuum skin package comprising:
a support member having an oxygen transmission rate (measured according to ASTM D-3985) in the range of from 80 to 500 cm³/m²-day-bar at 23° C. and 0% RH;
a cheese product on the support member; and
a flexible film draped over the cheese product and enclosing the cheese product on the support member, wherein the flexible film has an oxygen transmission rate (measured according to ASTM D-3985) greater than 60 cm³/m²-day-bar at 23° C. and 0% RH.

2. The package according to claim 1 wherein the flexible film is a multi-layer film comprising at least one layer comprising polyamide.

3. The package according to claim 1 wherein:
the support member has an oxygen transmission rate in the range of from 80 to 250 cm³/m²-day-bar at 23° C. and 0% RH;
the cheese product comprises gassing cheese; and
the flexible film has an oxygen transmission rate in the range of from 60 to 300 cm³/m²-day-bar at 23° C. and 0% RH.

4. The package according to claim 1 wherein:
the flexible film has an oxygen transmission rate greater than 500 cm³/m²-day-bar at 23° C. and 0% RH; and
the cheese product comprises moulded cheese.

5. The package according to claim 1 wherein:
the support member has an oxygen transmission rate in the range of from 80 to 500 cm³/m²-day-bar at 23° C. and 0% RH;
the cheese product comprises moulded cheese; and
the flexible film has an oxygen transmission rate in the range of from 500 to 1,000 cm³/m²-day-bar at 23° C. and 0% RH.

6. A method of making a vacuum skin package for cheese comprising the steps of:
providing a support member having an oxygen transmission rate (measured according to ASTM D-3985) in the range of from 80 to 500 cm³/m²-day-bar at 23° C. and 0% RH;
loading a cheese product on the support member;
draping a flexible film over the cheese product to enclose the cheese product on the support member, wherein the flexible film has an oxygen transmission rate (measured according to ASTM D-3985) greater than 60 cm³/m²-day-bar at 23° C. and 0% RH.
